(19) United States
(12) Patent Application Publication
(10) Pub. No.: US 2011/0133439 A1
(43) Pub. Date: Jun. 9, 2011

(54) RESTRAINT SYSTEM LOAD LIMITER

(75) Inventor: Lee Pearce, Halesowen (GB)

(73) Assignee: JAGUAR CARS LIMITED, Whitley (GB)

(21) Appl. No.: 12/629,946

(22) Filed: Dec. 3, 2009

(51) Int. Cl. B60R 22/28

(52) U.S. Cl. 280/805

(57) ABSTRACT

A vehicle occupant restraint system includes a load limiting device for and an anchorage position where the load limiting device may have a one-piece energy absorbing member configured for connecting the occupant restraint system and the vehicle anchorage position. The energy absorbing member may further include an integrally formed break-out region and force dissipation region. The force dissipation region may be adapted to inhibit translation of the energy absorbing member until a threshold force is applied to the occupant restraint system. When a threshold force is applied to the occupant restraint system, the anchorage position may become slidably engaged with at least a portion of a force dissipation region thereby displacing the energy observing member such that the occupant restraint system may be lengthened in order to reduce the load on the occupant.

### BACKGROUND OF THE INVENTION

1. Field of the Invention

The present invention relates to a load limiting device for an occupant restraint system in a vehicle, such as but not limited to a load limiting device that limits the load to an occupant's pelvis in order to enable controlled deceleration of the pelvis in a crash in order to minimize occupant injuries.

2. Background Art

The occupant restraint system of a vehicle typically includes a seatbelt, and the three-point seatbelt restraint system used in some vehicles includes both a shoulder belt and a lap-belt. The shoulder belt fits across the occupant's chest and the lap-belt fits across their pelvis to restrain the occupant in the event of a collision. The seatbelt restricts the occupants' forward motion to prevent contact with objects in front of the occupant such as the dashboard, windshield, steering wheel, or even another passenger's seat. During extremely forceful collisions, the occupant may actually be injured by the seatbelt itself as it applies forces to the bony structures of the body.

Load limiters, sometimes called “force limiters”, allow for the seatbelt to pay out or release in a somewhat controlled manner during forceful collisions. Some seatbelt systems use load limiters incorporated in a retractor mechanism where a torsion bar in the retractor twist when a force is applied, this twisting allowing the seatbelt to extend a bit farther. Other load-limiting systems may include complex mechanisms or numerous parts that interact to reduce the forces to an occupant. However, these mechanisms can be complex and not easily integrated into existing occupant restraint systems.

### BRIEF DESCRIPTION OF THE DRAWINGS

The present invention is pointed out with particularity in the appended claims. However, other features of the present invention will become more apparent and the present invention will be best understood by referring to the following detailed description in which:

FIG. 1 illustrates an occupant restraint system for a vehicle including a load limiting device according to one non-limiting aspect of the present invention.

FIG. 2 illustrates the detailed view of the load limiting device of one non-limiting aspect of the present invention.

FIGS. 3 through 5 illustrate load limiting devices and representative force-displacement curves according to various embodiments of the present invention.

### DETAILED DESCRIPTION OF THE DRAWINGS

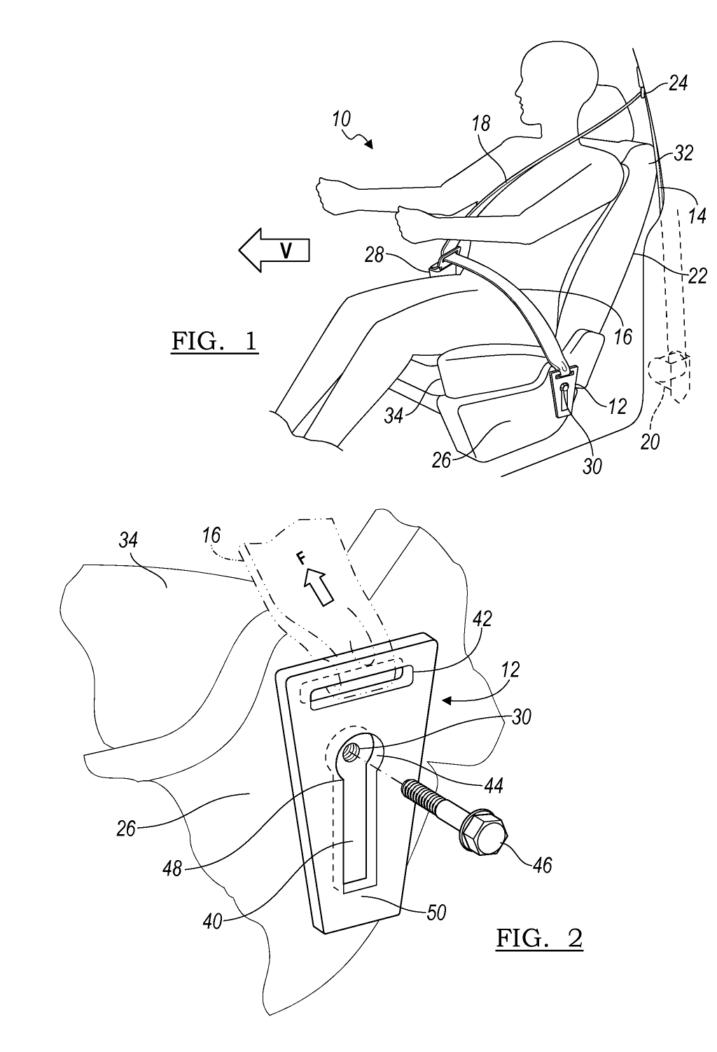

FIG. 1 illustrates a vehicle occupant restraint system 10 which includes a load limiting 12 device according to one non-limiting aspect of the present invention. The occupant restraint system 10 includes a seatbelt 14 which typical consists of a lap belt 16, which rests over the occupant's pelvis, and a shoulder belt 18, which extends across the occupant's chest. While the present invention is described with respect to a three-point seatbelt 14, as illustrated, it is also contemplated that the load limiting device may be included with two-point seatbelt systems, or any other occupant restraint system 10 that may be adapted for its use.

The occupant restraint system may further include a retractor 20. In normal driving, the retractor 20 lets you move freely in your seat while it keeps some tension on the shoulder belt 18 and lap belt 16. The retractor 20 may be a spring loaded spool attached to one end of the seatbelt 14 in order take up slack in seatbelt 14. During a collision or sudden deceleration, the retractor 20 automatically locks the seatbelt 14 to help restrain the occupant's body. The retractor 20 may be coupled to the vehicle along the floor, the vehicle B-pillar, or a suitable structure of the vehicle. Alternatively, the retractor 20 may be attached directly to the passenger seat 22.

The retractor 20 is typically located adjacent the shoulder belt 18. From the retractor 20, the seatbelt 14 may be secured through an upper anchor or shoulder anchor 24, the first connection point in a three-point occupant restraint system 10, as illustrated. The shoulder anchor 24 may redirect the seatbelt 14 from the retractor 20 across the chest of the vehicle occupant. The shoulder anchor 24 may be secured to a structural element of the vehicle such as the B-pillar or it may also be attached to the vehicle seat 22 or even a vehicle door. In some occupant restraint systems, the retractor 20 may be integrated with the shoulder anchor 24.

In the illustrated three-point occupant restraint system 10, the seatbelt 14 may be secured across the chest of the occupant from the shoulder anchor 24 and attached to a buckle assembly 28 at a second connection location. The buckle assembly 28, as illustrated, may be located on the inboard side of the seat 22. However the buckle assembly 28 may be located in any position which may be convenient to releasably secure the seatbelt 14 around the occupant. The buckle assembly 28 may also include a web guide which redirects the seatbelt 14 across the occupant's lap to form the lap-belt 14.

In the illustrated three-point occupant restraint system 10, the lap-belt 14 may then be connected to a vehicle anchor 30 at a third connection location. The anchor 30 may be located on the vehicle seat 22 such as on a lower portion of the vehicle seat 22 or adjacent the seat bottom 34. Alternatively, the anchor may be located on the rearward, outboard side of the seat frame 26, and on the opposite side of the seat as the buckle 28, as illustrated in FIG. 1. However, the anchor 30 may be located in any structural part of the vehicle including but not limited to the floor or the B-pillar of the vehicle.

In one non-limiting aspect of the present invention, the lap belt 16 may be further connected to a load limiting device 12. The load limiting device 12 may be connected to the vehicle anchor 30. Although the load limiting device 12 is illustrated in FIG. 1 as connecting the lap belt 16 and the vehicle anchor 30, the load limiting device 12 may also be positioned adjacent the shoulder belt 18, or at any other position along a portion of the seatbelt 14.

Further, it is understood that while the load limiting device 12 is pictured on the outboard side of the front driver's seat, the load limiting device 12 may be located inward or outward or along the retractor or B-pillar of the vehicle or it may also be located adjacent the seat back 32 or the shoulder of the occupant.

During a frontal crash, the occupant will travel forward towards the front of the car (V), as shown in FIG. 1 as indicated with the forward-pointing arrow. This motion will cause a load (F) to be generated at the anchorage position 30 in a generally forward and upward direction, as illustrated with the arrow. When this load (F) exceeds a predetermined breakout force, the load limiting device 12 may the absorb kinetic energy by sliding or translating with respect to the anchorage position 30.

FIG. 2 illustrates the load limiting device 12 of one non-limiting aspect of the present invention. The load limiting device 12 may be a one-piece energy absorbing member that may be configured for connecting the seatbelt 14 of the occupant restraint system 10 to the vehicle anchorage position 30. The load limiting device 12 is designed to absorb energy when a threshold force (F) is applied to the occupant restraint system 10, such as in a severe crash.

The load limiting device 12 is characterized as being ‘one-piece’ since a force dissipation region 40, an aperture 44 for attaching the device 12 to the vehicle and the method for absorbing energy may be integrated in a single bracket. Additionally, the one-piece load limiting device 12 may further include a slot 42 through which the seatbelt 14 attaches. The features may be integrated in a single bracket that may be formed as a single piece such as a stamped metal bracket or a molded plastic or composite bracket. As such, the one-piece load limiting device 12 may be easily integrated into an existed occupant restraint system 10.

In one aspect of the present invention the load limiting device 12 may include an aperture 44 for attaching the load limiting device to the vehicle anchorage position 30. The aperture 44 may be adapted to receive a one-piece anchor or fastener 46. The fastener 46 may be a threaded fastener such as a bolt or a screw, or, the fastener 46 may be any elongated member, such as a pin, adapted for connecting the load limiting device to the vehicle anchor 30 through the aperture 44. The anchor of fastener 46 provides a single point of anchorage to the vehicle. Since the load-limiting device 12 may be connected at a single point, it may also be configured to rotate about the fastener 46. The load limiting device 12 may also be configured to have an anti-rotation feature that prevents undesirable rotation about the fastener 46 such as where the seatbelt 14 is configured to remain in a prescribed orientation.

In normal driving conditions and normal loads and forces from the seatbelt 14, the fastener 46 may be retained in the aperture 44. The fastener 46 may be retained in the aperture 44 when the occupant exerts forces on the seatbelt 14 by adjusting their position in the seat, or even in low-impact crashes. But when the load (F) exceeds a threshold force, such as during a crash, the load limiting device 12 may slide or translate in the direction of the load, and the anchorage point 30 or fastener 46 may engage the force dissipation region 40. For example, the anchorage point 30 or fastener 46 may engage the force dissipation region 40 when the load exceeds 2 kN of force, but the load limiting device 40 may not be displaced with loads less than 2 kN. The threshold load of the load limiting device 12 may be a function of vehicle crash pulse, occupant size or age, and injuries targeted and therefore, the threshold force may be higher, such as 5 kN for some applications, or lower, such as 1 kN for other applications. When the load limiting device 12 slides and the anchorage point 30 or fastener 46 engages the force dissipation region 40, this will cause the seatbelt 14, or lap belt 16 as illustrated, to start to slacken, or effectively lengthen, allowing further displacement of the occupant.

The aperture 44 may be a circular opening formed in the load limiting device 12. In one non-limiting aspect of the present invention, the force dissipation region 40 is integrally formed with the aperture 44 so that the aperture 44 opens to the force dissipation region 40. Where the aperture 44 and force dissipation region 40 are integrally formed, they may form a key-hole shaped aperture, where the upper portion of the key-hole aperture is the circular shaped aperture 44 and the lower portion may be an elongated aperture or channel forming the force dissipation region 40.

Alternatively, the aperture 44 may be connected to the force dissipation region 40 by the break-out region 48. The break-out region 48 may be configured to retain the fastener 46 in the aperture 44 and prevent the fastener 46 from sliding through the force dissipation region 40 during normal driving conditions. Where a threshold force, or break-out force is applied to the occupant restraint system 10, such as during a crash, the break-out region 48 may deform and thereby allow the fastener 46 to engage the force dissipation region 40. When the force generated at the anchor position 30 or the force applied to the occupant restraint system 10 exceeds the break-out force, the fastener 46 will become slid ably engaged with the force dissipation region 40.

The break-out force may be tuned to the application, but is relatively high. The break-out force may be tuned for specific applications. Factors determining this force may be vehicle crash pulse, occupant size, required occupant injuries & specific timing of load limiting function. Consequently, the break out force & subsequent load limiting function will be specific to vehicle the load limiting device 12 is fitted to.

The break-out region 48 may be an opening where the opening is sized such that the anchorage position 30 or the fastener 46 is an interference fit with the opening. The break-out force may be the press-in force of the fastener 46 to the opening. The break-out force may be tuned by the varying dimension of the opening or by varying the thickness of the load limiting device 12. Where the break-out region 48 has been deformed, this may be permanent deformation where the load limiting device 12 does not return to its original shape or configuration such that the load limiting device 12 may need to be replaced. However, where the break-out region 48 is an interference fit with the fastener 46, there may not be permanent deformation or only elastic deformation of the load limiting device 12, the forces applied may be from sliding friction between the fastener 46 and the force dissipation region 40. Where there is a non-permanent deformation, the load limiting device 12 may be able to be re-used.

Alternatively, the break-out region may include a tab 52. In the event of a threshold force during an accident, the tab 52 may deform, defect or shear off. The breakout force required for the fastener 46 to move past the tab 52 may be tuned by varying the dimensions of the tab 52 or by varying the thickness of the load limiting device 12. The break-out force may further be tuned by varying the material characteristics of the load limiting device 12. Conversely, the fastener 46 may have shear strength greater than the break-out force or the force applied at a stop region 50.

Once the threshold, or break-out force, is applied, the fastener 46 may deform or move past the break-out region 48 and may subsequently engage the force dissipation region 40. The force dissipation region 40 may be an elongated aperture or channel formed in the load limiting device 12.

In one non-limiting aspect of the present invention, the elongated aperture of the force dissipation region 40 may have a width that is narrower than the aperture 44. The width of the elongate aperture may be generally the same as the width of the opening of the break-out region 48 so that once the break-out force is applied, a generally constant load is provided to the occupant restraint system 10 as the fastener 46 slides through the force dissipation region 40. Where the width of the elongated aperture is an interference fit with the fastener 46, the amount of force provided may be generally equal to the frictional force as the fastener 46 slides along the force dissipation region 40. The interference fit of the fastener 46 may cause deformation of force dissipation region 40, or the force may be from merely the frictional interaction of the fastener 46 and force dissipation region. However, the force provided as the fastener 46 slides through the force dissipation region 40 may be tuned by varying the diameter of the elongated slot as well as varying the thickness or material properties of the load limiting device 12.

The force dissipation region 40 may have an elongated slot where the width of the slot varies along the length of the force dissipation region 40. For example, for a certain crash characteristic, the elongated slot may have a wave-like profile where the width of the elongated slot alternates narrow and then wide. In another aspect, the elongated slot may start wider and then narrow in the middle and again get wider. The width and configuration of the elongated slot may be determined by the location of the load-limiting device 12 and the desired crash characteristics.

Alternatively, the force dissipation region 40 may be a solid area where the thickness or geometric and material characteristics of the area are such that the force dissipation region 40 resists translation in normal driving conditions. But when the break-out force is achieved, the force dissipation region 40 is deformed by the anchorage position 30 or the fastener 46.

Adjacent the force dissipation region 40, there may be a stop region 50. The stop region 50 may arrest the translation of the load limiting device 12 and further prevent the load limiting device 12 from separating from the anchorage position 30. The stop region 50 ensures that the occupant restraint system 10 remains connected to the vehicle at the stationary anchorage position 30.

In one non-limiting aspect of the present invention, the load limiting device 12 may further include the slot 42 through which the lap-belt portion 14 of the occupant restraint system may be attached. The slot 42 may be adapted to receive another portion of the seatbelt 14, such as the shoulder belt 18 in the case where the load limiting device 12 is located adjacent the seat back 32 or the upper portion of a seat. The slot 42 may be located adjacent the aperture 44 and on an opposite side of the aperture 44 as the force dissipation region 40.

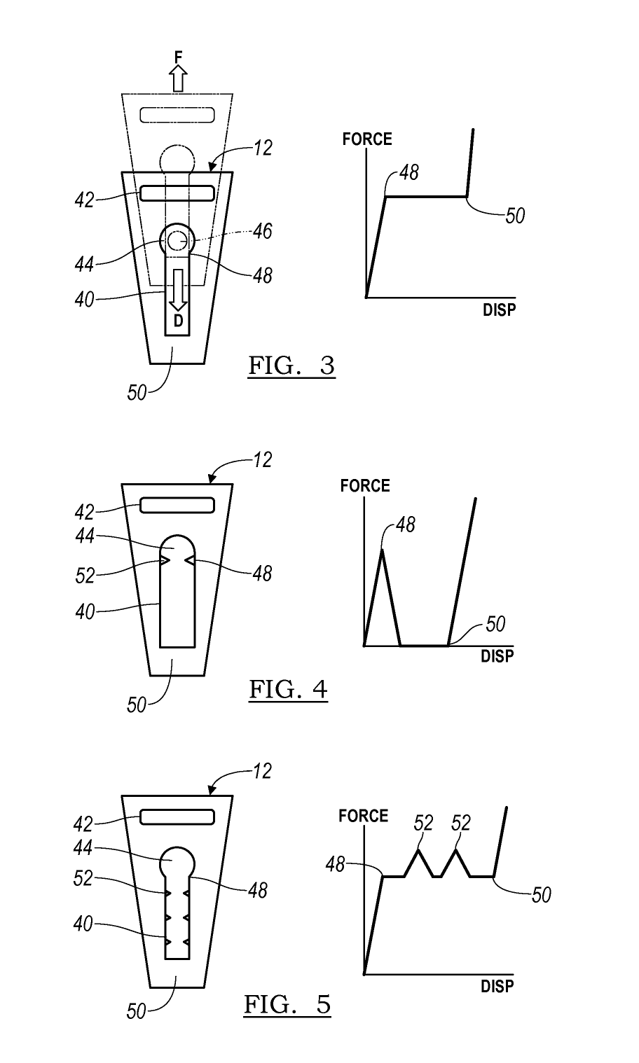

FIGS. 3 through 5 depict various configurations of the load limiting device 12 in which a force versus displacement curve of each configuration is illustrated. The graphs depict a representative force applied to the occupant restraint system 10 in relation to the displacement of the load limiting device 12. The anchor point 30 or fastener 46 remains in a fixed position, while the load limiting device 12 may be displaced. The load limiting device 12 may displaced in a direction of the force shown by arrow F, while the anchor point or fastener 46 move along the force dissipation region 40 along the direction D, as illustrated in FIG. 3. The load limiting device 12 is shown in phantom in its displaced position.

FIG. 3 further illustrates one non-limiting aspect of the present invention where the break-out region 48 may be an opening and the width of the force dissipation region 40 may be a relatively equal. The fastener 46 is housed in the aperture 44 in normal service conditions. Once a breakout-force is applied, the fastener 46 would engage the break-out region 48 and force dissipation region 40 along the direction D. As shown on the graph, the force increases until it reaches the break-out force. Subsequently, as the fastener 46 is drawn through the break-out region 48 and force dissipation region 40, the graph illustrates that a relatively constant force may be applied to the occupant restraint system 10 until the fastener 46 engages the stop region 50 of the load limiting device 12, at which point the force may increase again.

FIG. 4 illustrates another aspect of the present invention where the fastener 46 is housed in the aperture 44 during normal service conditions, but upon a crash where a break-out force is applied to the load limiting device 12, the fastener 46 would deflect or deform the tabs 52 in the break-out region 48. In this aspect, the force dissipation region 40 has an elongated aperture where the width of the elongated aperture is generally the same or larger than the width of aperture 44. The force-displacement curve illustrates that once the force applied to the fastener 46 exceeds the break-out force such that the tabs 52 are deformed, the fastener 46 would become slidably engaged with force dissipation region 40 and subsequently encounters a relatively low force or even no force, until the fastener 46 engages the stop region 50, at which point the force may increase again.

FIG. 5 illustrates another aspect of the present invention where the force dissipation region 40 includes several tabs 52 spaced apart along the force dissipation region 40. In this aspect, the fastener 46 may be housed in the aperture 44 during normal driving conditions, but upon a crash where a break-out force is applied to the load liming device 12, the fastener 46 would engage the break-out region 48 and subsequently translate through the force dissipation region 40. As illustrated in FIG. 5, the break-out region 48 is an opening and the force dissipation region 40 is a channel where the width of the channel is generally equal to the width of the opening.

As shown on the graph in FIG. 5, the force remains generally constant once the break-out force is applied and as the load limiting device 12 is displaced, until the fastener 46 encounters a tab 52 spaced along the channel. The tab 52, or pair of tabs 52, may form an opening with a width narrower than the width of the channel, thus the force applied to the occupant restraint system 10 increases as the fastener 46 translates and deflects or deforms the tabs 52. The graph illustrates a varying or step-wise force-displacement characteristic that is created when tabs 52 are located along the channel to increase the force.

The load limiting device 12 and force dissipation region 40 may be designed for a particular type of application or crash characteristic. The configuration of the force dissipation 40 may vary in addition to the aspects illustrated. For example, the force dissipation region 40 may be an elongated aperture with a varying width such that the force varies along the force dissipation region as the fastener 46 is displaced. Alternatively, the force dissipation region 40 may be an elongated aperture which is triangular-shaped that gradually widens or narrow so that the force gradually increases or decreases respectively, once the break-out force has been achieved.

The break-out force required may be tuned by varying the diameter of the elongated slot of the force dissipation region 40 as well as varying the thickness of the load limiting device 12. The break-out force may further be tuned by varying the material characteristics of the load limiting device 12.

In one non-limiting aspect of the present invention, the force dissipation region 40 could provide 40 to 50 millimeters of payout or length in the occupant restraint system 10. However, the length of the force dissipation region 40 may be longer or shorter for different applications or design and packaging requirements.

Once the load limiting device has been displaced such that the fastener 46 engages the stop region 50, displacement of the load limiting device 12 may be arrested which enables increased loads to meet regulatory tests. Once the fastener 46 engages the stop region 50, the load limiting device has performed its function of providing a controlled deceleration under crash loading conditions. In most configurations, the load limiting device 12 may be permanently deformed and may need to be replaced in order to be used again.

While the load limiting device 12 is illustrated as located adjacent the lap-belt 14, load limiting device 12 may be located adjacent the shoulder belt 18, or adjacent another portion of the seatbelt 14 where the load limiting device 12 may be easily integrated. While most load-limiting systems are only directed to controlling the forward motion of the occupant's torso or chest during collisions, it has been found that reducing forces applied to the pelvis during frontal collisions can also play a key role in preventing and managing occupant injuries from seatbelts. Occupant restraint systems may be designed to specifically reduce the pelvis loading in order to reduce injuries in crashes.

Further, the load limiting device 12, in conjunction with the other components of a restraint system such as airbags, seatbelts, and knee bolsters, etc may be used to balance forces acting on the body. For example, it may be advantageous to allow an occupants' pelvis to move forward so that their chest and head impact an airbag at a desired position or angle.

Also, while the load limiting device 12 of is shown in conjunction with a three-point restraint system, it may also be incorporated on two-point mounted seatbelt systems. As such, the load limiting device 12 may also be incorporated to control the amount of load in any vehicle application such as an airplane, roller coaster, or automobile. The load limiting device 12 may be incorporated into any existing vehicle where an anchorage position 30 may be adapted to receive a fastener such as a bolt, screw, pin or elongated member. The one-piece design of the load-limiting device 12 as well as the one-piece anchor of allows the load limiter 12 to be easily incorporated in any occupant restraint system 10.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention. The features of various implementing embodiments may be combined to form further embodiments of the invention.

What is claimed is:

1. An occupant restraint system for a vehicle comprising:
a seatbelt configured to secure an occupant within a seat;
a buckle anchored to the vehicle proximate a rearward, first side of the bottom of the seat, the buckle releasably connected to a portion of the seatbelt;
a load-limiting bracket anchored to the vehicle proximate a rearward, second side of the bottom of the seat, the seatbelt connected to the load-limiting bracket through a first aperture in order to position a portion of the seatbelt across a lap of the passenger; and
a pin anchoring the load-limiting bracket to the vehicle proximate the rearward, second side of the bottom of the seat, opposite the first side, the pin extending through a second aperture rearward of the first aperture,
wherein the second aperture is shaped with an upper portion and a lower portion such that when the seatbelt pulls on the bracket with a first amount of force, the pin remains located within the upper portion, and when the seatbelt pulls on the bracket with a second, greater amount of force, the bracket moves linearly relative to the pin such that pin moves out of the upper portion towards a least a portion of the lower portion.

2. The system of claim 1 wherein the second aperture is key-holed shaped such that the upper portion has a circular diameter that is wider than a width of an elongated, slot shaped lower portion.

3. The system of claim 2 wherein a size differential between the circular diameter of the upper portion and the width of the lower portion is proportional to a difference between the first amount of force and the second amount of force.

4. The system of claim 1 wherein the load limiting bracket is rotatable about the pin.

5. The system of claim 1 wherein the lower portion of the second aperture includes at least a first tab configured to narrow a corresponding portion of the lower portion such that a third amount of force, greater than the second amount of force, is required for the pin to move past the first tab.

6. The system of claim 1 wherein the upper portion of the second aperture is separated from the lower portion by at least one tab wherein a force at least equal to the second a second amount of force, is required for the pin to move past the tab.

7. A load-limiting device for a vehicle having a seatbelt and an anchorage position, the device comprising:
a one-piece energy absorbing member configured for connecting the seatbelt to the vehicle anchorage position by way of a fastener extending through an aperture formed within the energy absorbing member, the energy absorbing member including an integrally formed force dissipation channel opening to the aperture,
wherein when a threshold force is applied to the occupant restraint system, the energy absorbing member translates relative to the stationary position of the fastener such that the fastener slides through at least a portion of the force dissipation channel in a manner that lengthens the seatbelt.

8. The load-limiting device of claim 7 wherein the force dissipation channel is longer than the aperture, the width of the channel is narrower than the width of the aperture.

9. The load-limiting device of claim 8 wherein the channel has a generally constant width, such that as the fastener slides through the channel, a generally constant load is provided to the seatbelt as the energy absorbing member translates.

10. The load-limiting device of claim 8 wherein the channel has a varying width such that as the fastener slides through the channel, the channel is deformed in a way that a varying force is provided to the seatbelt as the energy absorbing member translates.

11. The load-limiting device of claim 10 wherein the channel further includes at least one tab located along the channel and as the fastener slides past the tab, the tab is deformed such that the force provided to the seatbelt increases as the fastener deforms the tab.

12. The load-limiting device of claim 7 wherein the energy absorbing member further includes a slot located on an opposite side of the aperture from the channel, the slot configured for receiving the lap-belt portion of an occupant restraint system.

13. The load-limiting device of claim 7 wherein the channel further includes at least one tab located along the channel wherein the tab is configured to narrow the channel such the tab is deformed by the fastener as the fastener slides through the channel.

14. The load-limiting device of claim 7 wherein the opening is formed by at least one tab separating the aperture and the channel wherein the tab is deformed by the fastener when the threshold force is applied, thereby allowing the fastener to slide through the channel.

15. A load-limiting device for an occupant restraint system, the device comprising:
an energy absorbing bracket configured for connecting the occupant restraint system to a vehicle anchorage position, the bracket including an integrally formed key-hole aperture, the key-hole aperture shaped to define an upper circular aperture portion and a lower elongated aperture portion; and
a break-out region located between the upper and lower portions, the break-out region deformable by the vehicle anchorage position when a threshold force is applied to the occupant restraint system,
wherein in a first position the bracket is located such that the fastener is housed in the upper aperture portion when a force less than the threshold force is applied to the occupant restraint system, and when a force greater than the threshold force is applied to the occupant restrain system, the bracket translates to a second position such that the fastener moves through the breakout region to slide through at least a portion of the of the lower portion, thereby lengthening the occupant restrain system and reducing the load on the occupant.

16. The load-limiting device of claim 15 wherein the width of the lower elongated aperture portion is narrower than width of the upper aperture.

17. The load-limiting device of claim 15 wherein the break-out region is an opening between the upper and lower aperture portion where the opening has a width in which the fastener has an interference fit such that the opening inhibits translation of the fastener until the force greater than the threshold force is applied to the occupant restraint system, wherein the threshold force is at least equal to the frictional force required to move the fastener through the opening.

18. The load-limiting device of claim 15 wherein the break-out region is an opening between the upper and lower aperture portion wherein the width of the opening and the width of the lower portion are generally equal, such that a constant load is provided to the occupant restraint system as the fastener slides through the break-out region and subsequently through the lower aperture portion, wherein the constant load is the amount of friction between the fastener and the opening and lower aperture as the fastener slides.

19. The load-limiting device of claim 15 wherein the break-out region includes at least one tab located between the upper and lower aperture portions to inhibit translation of the bracket until the force greater than the breakout threshold force is applied to the occupant restraint system, wherein the threshold force is at least as great as the force required to deform the tab.

20. The load-limiting device of claim 15 wherein the width of the lower aperture portion is greater than the width of the fastener such that once a threshold force is applied so that the fastener moves through the break-out region, there is generally no load applied to the occupant restraint system as the fastener slides through the lower aperture portion.
